(19) United States
(12) Patent Application Publication
(10) Pub. No.: US 2025/0169521 A1
(43) Pub. Date: May 29, 2025

(54) COMPOSITIONS AND METHODS FOR INCREASING THE PALATABILITY OF DRY PET FOOD

(71) Applicant: Société des Produits Nestlé S.A., vevey (CH)

(72) Inventor: Pascal Vanacker, AMIENS (FR)

(73) Assignee: Société des Produits Nestlé S.A., vevey (CH)

(21) Appl. No.: 18/912,185

(22) Filed: Oct. 10, 2024

Related U.S. Application Data
(60) Provisional application No. 63/603,705, filed on Nov. 29, 2023.

(51) Int. Cl. A23K 20/26; A23K 40/30; A23K 50/42

(52) U.S. Cl. CPC A23K 20/26; A23K 40/30; A23K 50/42

(57) ABSTRACT

Compositions and methods are provided to increase the palatability of dry pet foods. A dry pet food composition can comprise about 0.01 wt % to about 2 wt % of pentaphosphate, where the pentaphosphate is incorporated into at least one of a basal body of the dry pet food composition or a coating applied to the the dry pet food composition.

### CROSS REFERENCE TO RELATED APPLICATION

This application claims the benefit of and priority to U.S. Provisional Application Ser. No. 63/603,705 filed Nov. 29, 2023, the disclosure of which is incorporated in its entirety herein by this reference.

### BACKGROUND

The present disclosure generally relates to pet foods. More specifically, the present disclosure relates to compositions and methods for increasing the palatability of dry pet foods.

Of the main pet food categories, namely dry, semi-moist, and wet, dry pet foods are perceived as the least palatable. The existing solutions rely on optimizing the quality of raw materials (e.g. fat), increasing the moisture of the product, or increasing the application rate of flavor systems. The main drawback of these solutions is availability of the materials and/or the cost.

### SUMMARY

The present disclosure provides compositions and methods for increasing the palatability of dry pet foods using pentaphosphate. The present inventors have unexpectedly discovered that a specific phosphate compound, i.e., pentaphosphate, can significantly increase palatability of a dry pet food composition.

As such, in one embodiment, a dry pet food composition can comprise about 0.01 wt % to about 2 wt % of pentaphosphate. The pentaphosphate can be incorporated into at least one of a basal body of the dry pet food composition or a coating applied to the the dry pet food composition.

In another embodiment, a method for increasing the palatability of dry pet food can comprise incorporating about 0.01 wt % to about 2 wt % of pentaphosphate into at least one of a basal body of the dry pet food composition or a coating applied to the the dry pet food composition.

An advantage of the present disclosure is to improve the palatability of dry pet food.

Another advantage of the present disclosure is to use an economical and readily available compound as a palatant for pet food.

Still another advantage of the present disclosure is to improve the palatability of dry pet food without relying on optimizing the quality of raw materials (e.g. fat), increasing the moisture of the product, or increasing the application rate of flavor systems.

Additional features and advantages are described in, and will be apparent from, the following Detailed Description.

### DETAILED DESCRIPTION

All percentages expressed herein are by weight of the total weight of the composition and can be expressed as “wt %” unless expressed otherwise. When reference is made to the pH, values correspond to pH measured at 25° C. with standard equipment.

The term “pet” means any animal which could benefit from or enjoy the compositions provided by the present disclosure. The pet can be an avian, bovine, canine, equine, feline, hircine, lupine, murine, ovine, or porcine animal. The pet can be any suitable animal, and the present disclosure is not limited to a specific pet animal. The term “companion animal” means a dog or a cat. The term “dog” and “canine” are used interchangeably herein. The term “cat” and “feline” are used interchangeably herein. In one embodiment, the pet can be a feline.

The term “pet food” means any composition intended to be consumed by a pet.

The term “dry food” or “dry pet food” refers to a pet food having less than 10 wt. % moisture and/or a water activity less than 0.64, and in one aspect, both. “Kibbles” are pellets of dry pet food, and in one aspect, can be extruded pellets. A “basal body” is a pellet of dry pet food and does not include the coating, if any. A “basal composition” is a composition processed to form the basal body. A “semi-moist” food composition has 11 wt. % to 20 wt. % moisture and/or a water activity of 0.64 to 0.75, and in one aspect, both.

The term “complete and balanced” when referring to a food composition means a food composition that contains all known required nutrients in appropriate amounts and proportions based on recommendations of recognized authorities in the field of animal nutrition, and are therefore capable of serving as a sole source of dietary intake to maintain life or promote production, without the addition of supplemental nutritional sources. Nutritionally balanced pet food and animal food compositions are widely known and widely used in the art, e.g., complete and balanced food compositions formulated according to standards established by the Association of American Feed Control Officials (AAFCO) as of Jan. 1, 2023.

The term “pentaphosate” is used interchangeably with “pentapolyphosphate” and refers to the compound identified as PubChem CID 57418835, also identified as CAS 20410-55-3 and includes salts thereof.

As used herein and in the appended claims, the singular form of a word includes the plural, and vice versa, unless the context clearly dictates otherwise. Thus, the references “a,” “an” and “the” are generally inclusive of the plurals of the respective terms. For example, reference to “a compound” or “a method” includes a plurality of such “compounds” or “methods.”

Similarly, the words “comprise,” “comprises,” and “comprising” are to be interpreted inclusively rather than exclusively. Likewise, the terms “include,” “including” and “or” should all be construed to be inclusive, unless such a construction is clearly prohibited from the context. However, the embodiments provided by the present disclosure may lack any element that is not specifically disclosed herein. Thus, a disclosure of an embodiment defined using the term “comprising” also is a disclosure of embodiments “consisting essentially of” and “consisting of” the disclosed components. Where used herein, the term “example,” particularly when followed by a listing of terms, is merely exemplary and illustrative, and should not be deemed to be exclusive or comprehensive. Any embodiment disclosed herein can be combined with any other embodiment disclosed herein.

As used herein, “about” is understood to refer to numbers in a range of numerals, for example the range of −10% to +10% of the referenced number, within −5% to +5% of the referenced number, or in one aspect, within −2% to +2% of the referenced number, and in a specific aspect, within −1% to +1% of the referenced number. Furthermore, all numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

All patents, patent applications, publications, and other references cited or referred to herein are incorporated herein by reference to the extent allowed by law. The discussion of those references is intended merely to summarize the assertions made therein. No admission is made that any such patents, patent applications, publications or references, or any portion thereof, are relevant prior art for the present invention and the right to challenge the accuracy and pertinence of such patents, patent applications, publications, and other references is specifically reserved.

The inventors surprisingly found that pentaphosphate increased palatability of dry pet food compositions. Accordingly, the present disclosure provides compositions and methods for increasing the palatability of dry pet food, such as dry pet food kibbles. The compositions comprise at least one of pentaphosphate or a salt thereof.

As such, in one embodiment, a dry pet food composition can comprise about 0.01 wt % to about 2 wt % of pentaphosphate. The pentaphosphate can be incorporated into at least one of a basal body of the dry pet food composition or a coating applied to the the dry pet food composition.

In another embodiment, a method for increasing the palatability of dry pet food can comprise incorporating about 0.01 wt % to about 2 wt % of pentaphosphate into at least one of a basal body of the dry pet food composition or a coating applied to the the dry pet food composition.

In an embodiment, the dry pet food can comprise at least one vitamin and/or at least one mineral. Non-limiting examples of suitable vitamins include vitamin A, any of the B vitamins (e.g., B-1, B-2, B-3, B-5, B-6, B-7, B-9, and B-12), vitamin C, vitamin D, vitamin E, and vitamin K, including various salts, esters, or other derivatives of the foregoing. Non-limiting examples of suitable minerals include calcium, phosphorous, potassium, sodium, iron, chloride, boron, copper, zinc, magnesium, manganese, iodine, selenium, and the like. In one embodiment, the dry pet food composition can be a complete and nutritionally balanced pet food.

In an embodiment, the dry pet food comprises from about 5% to about 70% crude protein. The crude protein can comprise vegetable proteins, such as whole grain wheat, whole grain corn, soybean meal, soy protein concentrate, corn gluten meal, wheat gluten, cottonseed, and peanut meal; or animal proteins, such as casein, albumin, and meat protein. Non-limiting examples of suitable meat protein include beef, pork, lamb, rabbit, poultry, fish, and mixtures thereof. Non-limiting examples of suitable meat meals include rendered and ground parts from beef, pork, lamb, rabbit, poultry, fish, insects, and mixtures thereof. Non-limiting examples of suitable meat include any meat and meat by-product such as whole-carcass beef and mutton; lean pork trim; beef shanks; veal; beef and pork cheek meat; and meat by-products such as lips, tripe, hearts, tongues, mechanically deboned beef, chicken or fish, beef and pork liver, lungs, kidneys, and the like. The meat can be emulsified or particulate. In an embodiment, the meat is chicken. In one embodiment, the dry pet food compositions can comprise protein in amounts from about 5%, 10%, 15%, 20%, 25%, 30%, 35%, 40%, 45%, 50%, or even 55% to about 20%, 25%, 30%, 35%, 40%, 45%, 50%, 55%, 60%, 65%, or even 70% by weight, including various subranges within these amounts.

In an embodiment, the dry pet food comprises from about 5% to about 50% fat. Non-limiting examples of suitable fats include animal fats and vegetable fats. Preferably the fat source is an animal fat source, for example, beef fat, pork fat, poultry fat. Vegetable oils, such as corn oil, sunflower oil, safflower oil, rape seed oil, soy bean oil, olive oil and other oils rich in monounsaturated and polyunsaturated fatty acids, and medium chain triglycerides can be used. In one embodiment, the dry pet food compositions can comprise fat in amounts from about 5%, 10%, 15%, 20%, 25%, 30%, 35%, 40%, or even 45% to about 20%, 25%, 30%, 35%, 40%, 45%, or even 50% by weight, including various subranges within these amounts.

In an embodiment, the dry pet food comprises from about 5% to about 60% carbohydrate. Non-limiting examples of suitable carbohydrates include grains or cereals such as rice, corn, millet, sorghum, alfalfa, barley, soybeans, canola, oats, wheat, rye, triticale and mixtures thereof. The compositions can comprise other materials such as dried whey and other dairy by-products. In one embodiment, the dry pet food compositions can comprise protein in amounts from about 5%, 10%, 15%, 20%, 25%, 30%, 35%, 40%, 45%, 50%, or even 55% to about 20%, 25%, 30%, 35%, 40%, 45%, 50%, 55%, or even 60% by weight, including various subranges within these amounts.

In an embodiment, the dry pet food comprises one or more fiber sources. The term “fiber” includes all sources of “bulk” in the food whether digestible or indigestible, soluble or insoluble, fermentable or non-fermentable. Preferred fibers are from plant sources such as marine plants but microbial sources of fiber may be used. Soluble fibers and/or insoluble fibers may be utilized. Non-limiting examples of suitable fiber sources include beet pulp (from sugar beet), gum arabic, psyllium, rice bran, carob bean gum, citrus pulp, pectin, fructooligosaccharide, short chain oligofructose, mannanoligofructose, soy fiber, arabinogalactan, galactooligosaccharide, arabinoxylan, and mixtures thereof.

The fiber source can be a fermentable fiber. Fermentable fiber has previously been described to provide a benefit to the immune system of a companion animal. Fermentable fiber or other compositions known to skilled artisans that provide a prebiotic to enhance the growth of probiotics within the intestine may be incorporated into the dry pet food.

In some embodiments, the ash content of the dry pet food ranges from less than 1% to about 15%, preferably from about 5% to about 10%.

In various embodiments, the dry pet food compositions may comprise additional ingredients such as amino acids, nucleic acids, fillers, palatability enhancers, binding agents, flavorants, stabilizers, emulsifiers, sweeteners, colorants, buffers, salts, coatings, condiments, preservatives, and the like known to skilled artisans. Non-limiting examples of antioxidants include butylated hydroxyanisole (“BHA”) and butylated hydroxytoluene (“BHT”), vitamin E (tocopherols), and the like. Non-limiting examples of suitable preservatives include potassium sorbate, sorbic acid, sodium methyl para-hydroxybenzoate, calcium propionate, propionic acid, and combinations thereof. The compositions may also comprise carotenoids such as alpha-carotene, lycopene, lutein, zeaxanthin and beta-cryptoxanthin. Additional ingredients may also be included, for example, digestive aids, health aids, and the like.

Examples of suitable flavorants include yeast, tallow, rendered animal meals (e.g., poultry, beef, lamb, pork), flavor extracts or blends (e.g., grilled beef), and the like. Suitable colorants that may be used in the meat analog chunks and/or the gravy include FD&C colors, such as blue no. 1, blue no. 2, green no. 3, red no. 3, red no. 40, yellow no. 5, yellow no. 6, and the like; natural colors, such as caramel coloring, annatto, chlorophyllin, cochineal, betanin, turmeric, saffron, paprika, lycopene, elderberry juice, pandan, butterfly pea and the like; titanium dioxide; iron oxides; and any suitable food colorant known to the skilled artisan. Suitable spices that may be used in the meat analog chunks and/or the gravy include parsley, oregano, sage, rosemary, basil, thyme, chives and the like.

The dry pet foods disclosed herein may be any food formulated for consumption by a pet, such as a dog or cat. In an embodiment, the dry pet food provides complete nutrition as defined by the Association of American Feed Control Officials (AAFCO) and which depends on the type of animal for which the composition is intended (e.g., a dog or a cat). In another embodiment, the composition can be a supplement. Such a supplement can be added to a food composition or be administered in conjunction with a food composition, or administered separately. In some embodiments where the composition is a supplement, to enhance the length of time the supplement can be stored, the dietary supplements can have a total moisture content between about 2% and about 10% by weight of the supplement. In one embodiment, the total moisture content can be less than 5% by weight of the supplement. Similarly, the dietary supplement can have a water activity in the range of 0.20 to 0.6. In one aspect, the water activity can be less than 0.55.

Selection of the amounts of each additional ingredient is known to skilled artisans. Specific amounts for each additional ingredient will depend on a variety of factors such as the ingredient included in the coating composition; the species of animal; the animal's age, body weight, general health, sex, and diet; the animal's consumption rate; the purpose for which the pet food is administered to the animal; and the like. Therefore, the identity and amounts of the additional ingredients may vary widely and may deviate from the preferred embodiments described herein.

The present disclosure also provides methods for making dry pet food. In an embodiment, the ingredients of the dry basal composition are milled, for example by a hammer mill. The milled ingredients can be extruded and expanded, and as the ropes exit the extruder they are cut into kibbles by rotating knives or another suitable cutting device. The kibbles can be dried to a moisture content less than about 20%, preferably less than about 15%, and more preferably less than about 10%.

In an embodiment, the dry kibbles can be coated with a coating composition, for example by spraying. The coating composition can include animal fat and palatants. Non limiting examples of palatants are liquid or dried hydrolyzed animal by-product parts, whole yeast, autolyzed yeast, yeast extract, plant oils, and other flavor compounds known to those skilled in the art. In a preferred embodiment, the coating composition includes animal fat and hydrolyzed animal by-products. The kibbles can then be filled into suitable packaging which is subsequently sealed.

At least one of pentaphosphate or a salt thereof is added to the dry pet food, for example in the ingredients of the dry basal composition and/or in the coating composition. If at least one of pentaphosphate or a salt thereof is added to the ingredients of the dry basal composition, preferably the addition is before milling.

In an embodiment, a total amount of pentaphosphate or a salt thereof can be from about 0.01 wt % to about 2 wt %, or more preferably from about 0.1 wt % to 1 wt % of the composition, and, in one aspect, the dry pet food can be a cat food. In another embodiment, a total amount of pentaphosphate or a salt thereof can be from about 1 wt % to about 10 wt % of the coating, or more preferably from about 4 wt % to about 6 wt % of the coating.

### EXAMPLES

By way of example and not limitation, the following non-limiting examples are illustrative of various embodiments provided by the present disclosure.

### Example 1—Dry Cat Food Study

A study of the following phosphates were assessed as compared to TSPP (tetrasodium pyrophosphate) when applied on dry cat food: pentaphosphate (sodium petaphosphate), hexametaphosphate, trisodium trimetaphosphate, and pentasodium tri (poly) phosphate (STPP).

The phosphates were included at the rate of 0.5% equivalent PO₄ on a Premium Dry Cat finished product, Friskies Grand Menu (normalizing the amount of phosphorus application). The coating blend included yeast at 1% and was applied on chicken fat coated at 4.5% to the kibbles.

40 cats were tested over a period of exposure of 19 hours using paired tests versus the control product using TSPP as phosphate salt in the coating.

Pentaphosphate was the sole long chain phosphate among those assessed that could match the palatability performance of TSPP (non-significant difference with a p-value>0.05) as shown in Table 1.

TABLE 1

| | Test | Control |
|---|---|---|
| Phosphate | Consumption (%) | Consumption (%) |
| Pentaphosphate | 48.2 | 51.8 |
| Hexametaphosphate | 42.5 | 57.5 |
| Trisodium | 34.6 | 65.4 |
| trimetaphosphate | | |
| Pentasodium | 33.5 | 66.5 |
| tri(poly)phosphate | | |
| (STPP) | | |

Unexpectedly, pentaphosphate was the only palatant that performed as well as TSPP (a well known palatant). Notably, the chemical structures are not similar in nature and could not predict the presently discovered affect, esp[ecially as other sodium phosphates did not replicate the TSPP results.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A dry pet food composition comprising about 0.01 wt % to about 2 wt % of pentaphosphate, wherein the pentaphosphate is incorporated into at least one of a basal body of the dry pet food composition or a coating applied to the the dry pet food composition.

2. The dry pet food composition of claim 1, further comprising protein, fat, and carbohydrates.

3. The dry pet food composition of claim 2, wherein the protein is present in an amount from about 5 wt % to about 70 wt %.

4. The dry pet food composition of claim 2, wherein the fat is present in an amount from about 5 wt % to about 50 wt %.

5. The dry pet food composition of claim 2, wherein the carbohydrate is present in an amount from about 5 wt % to about 60 wt %.

6. The dry pet food composition of claim 1, wherein the dry pet food composition is a complete and nutritionally balanced pet food.

7. The dry pet food composition of claim 1, wherein the dry pet food composition is formulated for a feline.

8. The dry pet food composition of claim 1, wherein the dry pet food composition comprises about 0.1 wt % to about 1 wt % of pentaphosphate.

9. The dry pet food composition of claim 1, wherein the pentaphosphate is present in the coating.

10. A method for increasing the palatability of dry pet food comprising: incorporating about 0.01 wt % to about 2 wt % of pentaphosphate based on the total weight of the dry pet food into at least one of a basal body of the dry pet food composition or a coating applied to the the dry pet food composition.

11. The method of claim 10, wherein the dry pet food composition is extruded.

12. The method of claim 10, wherein the pentaphosphate is present in the coating.

13. The method of claim 10, wherein the dry pet food composition is a cat food.

14. The method of claim 10, wherein the dry pet food composition is a complete and nutritionally balanced pet food.

15. The method of claim 10, wherein the dry pet food composition comprises about 0.1 wt % to about 1 wt % of pentaphosphate.
